(19) United States
(12) Patent Application Publication
(10) Pub. No.: US 2007/0179879 A1
(43) Pub. Date: Aug. 2, 2007

(54) Method and computer program product for creating a unique online auction

(75) Inventors: Julia S. Pomeranz, Tarrytown, NY (US); Caroline Ramsey, New York, NY (US); Maricar R. Rances, Floral Park, NY (US); Seth R. Jacobs, New York, NY (US); Jennifer L. Morrow, Chandler, AZ (US)

Correspondence Address: STERNE, KESSLER, GOLDSTEIN & FOX P.L.L.C., 1100 NEW YORK AVENUE, N.W., WASHINGTON, DC, 20005, US

(73) Assignee: American Express Marketing & Development, Corp., a Delaware Corporation

(21) Appl. No.: 11/256,950

(22) Filed: Oct. 25, 2005

(51) Int. Cl. G06Q 40/00

(52) U.S. Cl. 705/37

(57) ABSTRACT

A computer-based method for performing an online auction of an item in which loyalty rewards points can be used as currency is presented. The method includes the following steps: Information about a large component of the auction item is displayed on a website, which allows customers to view the information over the Internet using a web browser. A bid is received from each interested customer. Each interested customer's bid can include an indication of the number of loyalty rewards points to be redeemed for the large component. A winner of the auction is selected based on the bids. For example, the interested customer bidding the greatest number of loyalty rewards points can be selected as the winner of the auction. The winner is solicited to select from a number of additional components, thereby allowing the winner of the auction to customize the auction item that is won.

### BACKGROUND OF THE INVENTION

1. Field of the Invention

The present invention generally relates to loyalty rewards programs, and more particularly to increasing customer participation in loyalty rewards programs.

2. Related Art

Loyalty programs are designed to encourage and increase a particular customer behavior by offering a variety of rewards that can be redeemed using accumulated loyalty rewards points. Typically, a customer can redeem her loyalty rewards points for rewards, such as merchandise, gift certificates, charitable donations, cash, or points/miles in a participating partner loyalty program. In a typical redemption scenario, as long as the customer has adequate points, she can redeem a fixed number of loyalty rewards points for a particular reward.

In addition to the typical redemption scenarios mentioned above, sometimes loyalty rewards points are redeemed in a contest. A typical contest in which loyalty rewards points are redeemed is an auction. The basic premise of an auction is that different participants “bid” for an item being offered. Typically, after a designated period of time, the high bidder(s) is (are) declared the winner(s) and awarded the item.

A problem with auctions is that the item being auctioned may not be well-suited for each auction participant. This is especially true when the item being auctioned is an experience. For example, the experience may be attendance at a unique event, which includes airfare, and hotel accommodations to enhance the unique event. However, if the eventual winner lives in (or near) the city in which the event is to take place, the airfare and hotel accommodations are not necessary. Since the item includes airfare and hotel accommodations, customers living in or near the city may be discouraged from participating in the auction—therefore decreasing the total number of potential auction participants.

Given the foregoing, what is needed is a method and computer program product for creating a unique online auction.

### BRIEF DESCRIPTION OF THE INVENTION

The present invention meets the above-identified needs by providing a method and computer program product for creating a unique online auction.

An embodiment of the present invention provides a computer-based method for performing an online auction of an item, which comprises a large component and additional components. The method includes the following steps. Information about the auction item is displayed on a website, thereby allowing customers to view the information over the Internet using a web browser. A bid for the large component of the auction item is received from each interested customer. An interested customer bidding the greatest amount of currency is selected as a winner of the online auction. A solicitation for the winner to select a subset of the additional components of the auction item is displayed. The winner's selection is received, thereby allowing the winner of the auction to customize the auction item that is won.

An example advantage of an online auction in accordance with an embodiment of the present invention is that it has the potential to increase customer bids. As described in more detail herein, an online auction in accordance with an embodiment of the present invention provides a winner with the opportunity to customize the item that is won based on his/her preferences. In so doing, customers will potentially perceive greater value in such an auction because it allows them to select components that they find most desirable. Compared to traditional auctions, customers will potentially be more excited about a customized auction in accordance with an embodiment of the present invention. Higher customer excitement may drive up the bids on such customized online auctions.

Another example advantage of an online auction in accordance with an embodiment of the present invention is that it has the potential to generate additional opportunities for merchants to cross-sell merchandise. A winner of the online auction may opt to purchase additional components which are not included with the original auction item. In this way, the winner can supplement the auction item that is won. For example, if the item that is being auctioned is a trip, the winner may opt to purchase additional components such as airfare, car rental, hotel accommodations, a camera and/or luggage.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary environment in which the present invention, in an embodiment, would be implemented.

FIG. 2 is a flowchart illustrating a computer-based method for performing an online auction in accordance with an embodiment of the present invention.

FIG. 3 is a flowchart illustrating a second computer-based method for performing an online auction in accordance with a second embodiment of the present invention.

FIG. 4 is a block diagram of an exemplary computer system useful for implementing an embodiment of the present invention.

### DETAILED DESCRIPTION

### I. Introduction

The present invention is directed to a method and computer program product for performing an online auction of an item, in which the winner(s) of the auction customizes the item that is (are) won. An item being auctioned can include a tangible prize or an “experience.” Examples of a tangible prize can include, but are not limited to, a car, a computer, cash, or the like. Examples of an “experience” can include, but are not limited to, a golfing trip with a famous athlete, dinner with a celebrity, a trip to a vacation destination, or the like.

The terms “user,” “end user,” “consumer,” “customer,” “card members,” and/or “participant,” and/or the plural form of these terms are used interchangeably throughout herein to refer to those persons or entities capable of accessing, using, be affected by and/or benefiting from the tool that the present invention provides for participating in an online auction.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is now described in more detail herein in terms of an exemplary loyalty rewards program developed by American Express Travel Related Services Company, Inc. (“American Express”). This is for convenience only and is not intended to limit the application of the present invention. In fact, after reading the following description, it will be apparent to one skilled in the relevant art(s) how to implement the following invention in alternative embodiments. For example, other forms of currency, in addition to loyalty rewards points, can be used to bid on and/or purchase items in an online auction; and/or other transaction card issuers, program sponsors and the like may utilize the invention; all in accordance with one or more embodiments of the present invention described herein without deviating from the scope and spirit thereof.

### II. Example System

An example loyalty rewards program is the Membership Rewards® (MR) program provided by American Express. The American Express MR program provides certain card members with an opportunity to establish a MR account which facilitates the earning and collecting of loyalty rewards points. Card members may earn loyalty rewards points from, for example, charging purchases on an American Express transaction card, purchasing certain products at affiliated vendors (e.g., airline tickets), purchasing services from affiliated vendors (e.g., hotel stays), and purchasing products on websites using the charge card account number. MR loyalty rewards points may be used by card members to purchase items, obtain discounts on products or services, or to obtain special upgrades or prizes.

According to one embodiment, an online system allows MR members to participate in an online auction. In an example, only a subset of all customers may participate in the closed auction. The subset can include, for example, card members in good standing who are enrolled in both the MR and Manage Your Card Account (MYCA) programs. In addition, customers not meeting other types of criteria can be excluded. For example, customers that are under the age of 21 can be restricted from participating in an online auction performed in accordance with an embodiment of the present invention.

“Currency” used for bidding in the auction can be represented by a balance of loyalty rewards points available in a card member's loyalty account. Other types of currency can also be used, such as cash rebates, cash, or the like. A card member's previously established MR account can be used to track the loyalty rewards points (currency); hence, an additional account (e.g., a unique auction account) is not necessarily needed for this purpose. According to an embodiment, the auction system retrieves pre-existing data from the card member's MR account via online access (e.g., through a MYCA account or similar customer account), and then automatically displays the loyalty point total. In this way, the user is never required or permitted to submit or edit loyalty point balance information that is recorded in the system.

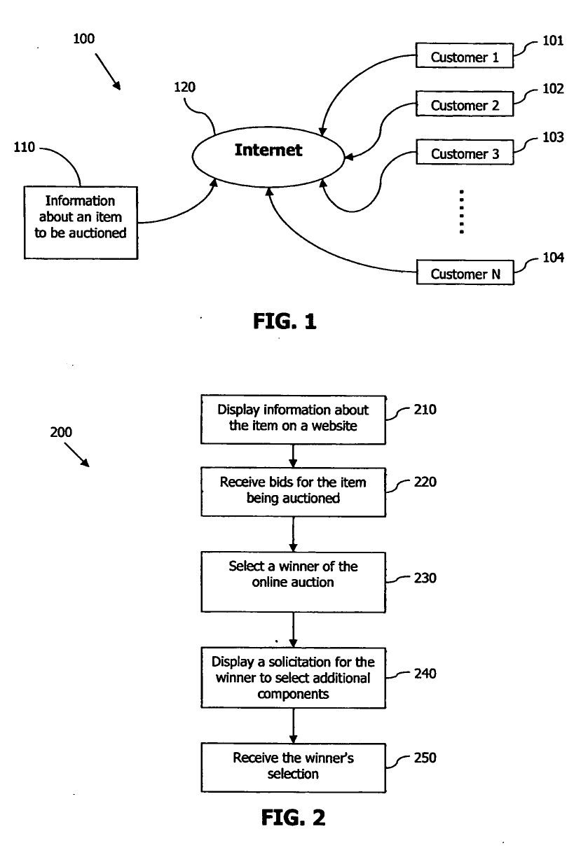

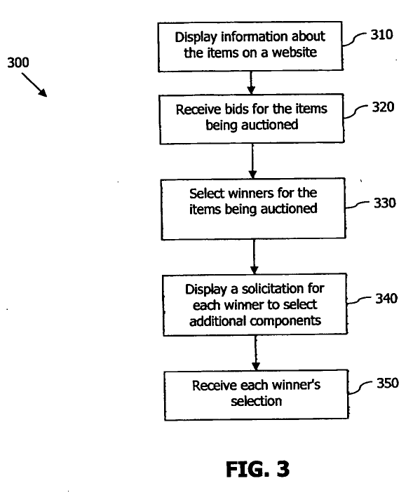

FIG. 1 illustrates a computer-based system 100 for performing an online auction in accordance with an embodiment of the present invention. System 100 generally shows the Internet 100 to which a customer 1, a customer 2, a customer 3, and a customer N have access. The actual number of customers, N, can be quite large (e.g., hundreds, thousands, or more). As is well-known, these customers can view information displayed on the Internet 120 by using a web browser. An organizer of the online auction (e.g., American Express) can display information about an item to be auctioned (indicated by block 110) on the Internet 120. In this way, customers 1, 2, 3, and N can view the information about the item being auctioned by the organizer. Example methods of using system 100 to conduct an online auction is described below with reference to FIGS. 2 and 3.

### III. Example Methods

Referring to FIG. 2, there is shown a flowchart illustrating a computer-based method 200 for performing an online auction of an item in accordance with an embodiment of the present invention. The auction item includes a large component and additional components. For example, the large component could be a trip and the additional components could include airfare, hotel accommodations, luggage, car rental, or the like.

Method 200 begins at a step 210 in which information about the item being auctioned is displayed on a website. In this way, as is well-known, customers can view the information over the Internet by using a web browser (e.g., as shown in system 100 of FIG. 1). In one example, the information only pertains to the large component of the auction item, with none of the information pertaining to the additional components. In another example, the information pertains to the large component and the additional components of the auction item. In additional examples, the information pertains to add-on components (described in more detail below) to the auction item, or portions or combinations of the large component, the additional components and the add-on components.

For instance, the large component of the auction item being displayed for auction in step 210 may be dinner with an actor in a particular city in which the actor is to attend a premier of his/her movie. In such an instance, the additional components could include, for example, round-trip airfare, two-nights stay at a four-star hotel, limousine service, a full day of spa services, and movie premier tickets. Add-on components could be included with the auction item provided the winner redeems additional loyalty rewards points. An example of an add-on component could include passes to attend the movie premier pre-party provided the winner redeems an additional 20,000 loyalty rewards points.

In a step 220, bids for the item being auctioned are received from interested customers. Each interested customer's bid can include a number of loyalty rewards points to be redeemed for the large component of the auction item. Continuing with the example from above, an interested customer may bid 500,000 loyalty rewards points to win the dinner with the famous actor.

In a step 230, a winner of the online auction is selected based on the bids received in step 220. For example, the winner of the auction can be the interested customer that bid the greatest number of loyalty rewards points. For instance, if each of the other interested customers' bid was less than 500,000 loyalty rewards points, an interested customer that bid 500,000 loyalty rewards points would be selected as the winner of the online auction.

In a step 240, a solicitation for the winner to select a subset of the additional components is displayed. For example, there may be five additional components from which the winner is to select three. Continuing with the example from above, the winner may choose from: (i) round-trip airfare, (ii) two-nights stay at a four-star hotel, (iii) limousine service, (iv) a full day of spa services, and (v) movie premier tickets. By allowing the winner to select from the additional components, this online auction method allows the winner to customize the overall item that is won based on his/her preferences. For instance, the winner may live in (or nearby) the city in which the dinner with the actor is to be held, in which case items (i) and (ii) may not be desired.

In a step 250, the winner's selection is received by the auction organizer.

Several variations or modifications to method 200 are included within the scope of the present invention. As a first example, as mentioned above, the winner of the auction can select add-on components by paying (redeeming) additional currency (loyalty rewards points). For instance, by redeeming an additional 20,000 loyalty rewards points the winner can select to attend the movie premier pre-party.

As a second example, the additional components can have different option levels. Using the example from above, the airfare additional component can include a first-class option or a coach option. In one example, the higher level option (e.g., first-class airfare) would be an upgrade option, the selection of which requiring additional loyalty rewards points (e.g., 20,000 points); whereas the lower level option (e.g., coach airfare) would be a fee-free option, the selection of which requiring no additional loyalty rewards points. In another example, the winner may be solicited to make a predetermined number (e.g., three) selections and each option level can be associated with a number of selections. The higher level option can be counted as a greater number of selections compared to the lower level option. For instance, a winner may be solicited to make three selections from five possible additional components. The high level option (e.g., first-class airfare) may be counted as two selections (or some other number as would be apparent to a person skilled in the relevant art(s)), whereas the low level option (e.g., coach airfare) may be counted as one selection.

The examples illustrated above include a high level option and a low level option. It is to be appreciated that this is for illustrative purposes only, and not a limitation. In particular, more option levels can be included as would be apparent to a person skilled in the relevant art(s).

As a third example, additional add-on components and/or upgrade options can be suggested to the winner based on the winner's selection that was received in step 250. In this way, the suggested add-ons and upgrades would be targeted toward the winner's preferences.

Referring to FIG. 3, there is shown a flowchart illustrating a computer-based method 300 for performing an online auction of multiple items in accordance with an embodiment of the present invention. Each of the multiple items includes a substantially identical large component and additional components.

Using an example from above, the large component may be dinner with an actor. Multiple winners can be selected to have dinner with the actor. In this way, the dinner party may include, for example, the actor a first winner, a second winner, a third winner, and a fourth winner. This dinner is substantially identical for each of the four winners, but not identical. That is, the first winner has dinner with the actor and the second, third, and fourth winners; whereas, the second winner has dinner with the actor and the first, third, and fourth winners.

Method 300 begins at a step 310 in which information about the items being auctioned is displayed on a website. As with step 210 of method 200, step 310 enables customers to view the information over the Internet via a web browser (e.g., as shown in system 100 of FIG. 1).

In a step 320, bids for the auction item are received from interested customers. Similar to step 210 described above, each interested customer's bid can include a number of loyalty rewards points to be redeemed.

In a step 330, winners are selected for the auction items. The number of winners selected corresponds with the number of items being auctioned. In other words, N winners are chosen to win N auction items, where N is a predetermined integer value (e.g., two, three, four, five or any other positive integer value). The N highest bidders can be selected as the N winners. That is, each of the N winners would have bid a greater number of loyalty rewards points than any of the other respective interested customers. Using the example from above, the four highest bidders would be selected as the four winners to have dinner with the actor.

Steps 340 and 350 are similar to steps 240 and 250, respectively. In step 340, a solicitation is displayed requesting that each of the winners select a subset of the additional components. In step 350, each winner's selection is received.

In an example implementation of method 300, an available number of each additional component is less than the number of winners, N. In this case, the order in which the winners select the additional components becomes important. The order that the winners select the additional components can be determined in at least two different ways. In a first example, the order in which the winners select the additional components is based on a relative time order in which each winner's bid was received. In this way, interested customers are encouraged to bid earlier—if they win, they would have first choice (or priority) among the additional components. In a second example, the order in which the respective winners select the additional components is based on their respective bids. The winner bidding the greatest number of loyalty rewards points would be permitted to select from the additional components first, the second highest bidder would select second, and so on, with the winner with the lowest winning bid selecting last.

An example difference between method 300 and method 200, is that method 300 includes a multitude of items that are awarded to a corresponding multitude of winners. However, as will be apparent to a person skilled in the relevant art(s), many of the variations and modifications described above with reference to method 200 can be implemented with respect to method 300.

### IV. Example Implementations

Embodiments of the present invention (e.g., system 100, method 200, method 300 or any part(s) or function(s) thereof) may be implemented using hardware, software or a combination thereof and may be implemented in one or more computer systems or other processing systems. However, manipulations performed by the present invention were often referred to in terms, such as receiving or selecting, which are commonly associated with mental operations performed by a human operator. No such capability of a human operator is necessary, or desirable in most cases, in any of the operations described herein which form part of the present invention. Rather, the operations are usually machine operations. Useful machines for performing the operation of the present invention include general purpose digital computers or similar devices.

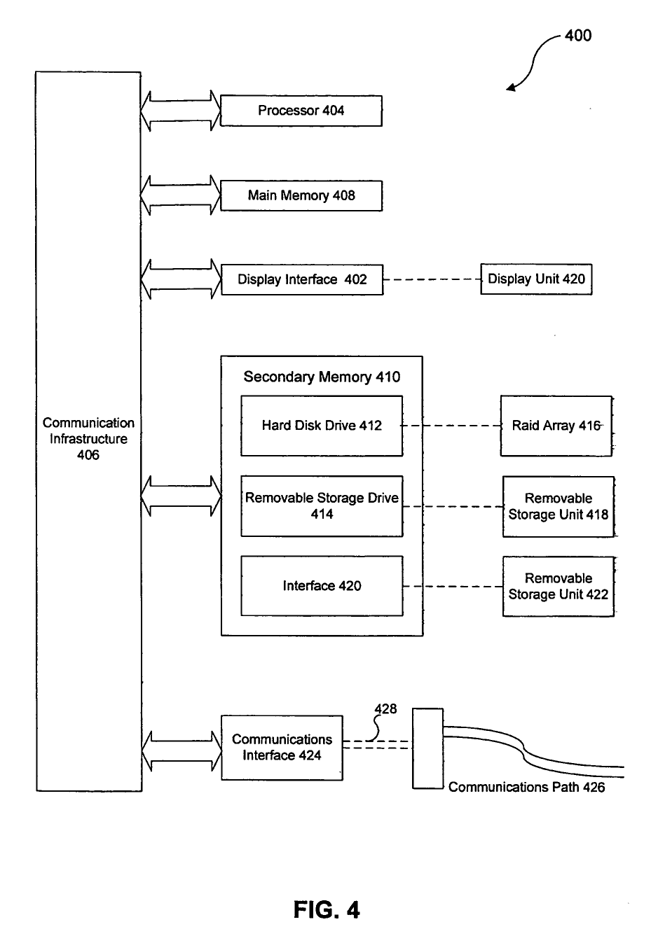

In fact, in one embodiment, the invention is directed toward one or more computer systems capable of carrying out the functionality described herein. An example of a computer system 400 is shown in FIG. 4.

The computer system 400 includes one or more processors, such as processor 404. The processor 404 is connected to a communication infrastructure 406 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 400 can include a display interface 402 that forwards graphics, text, and other data from the communication infrastructure 406 (or from a frame buffer not shown) for display on the display unit 430.

Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well known manner. Removable storage unit 418 represents a floppy disk, magnetic tape, optical disk, etc. which is read by and written to by removable storage drive 414. As will be appreciated, the removable storage unit 418 includes a computer usable storage medium having stored therein computer software and/or data.

In alternative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 414, a hard disk installed in hard disk drive 412, and signals 428. These computer program products provide software to computer system 400. The invention is directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 404 to perform the features of the present invention. Accordingly, such computer programs represent controllers of the computer system 400.

In an embodiment where the invention is implemented using software, the software may be stored in a computer program product and loaded into computer system 400 using removable storage drive 414, hard drive 412 or communications interface 424. The control logic (software), when executed by the processor 404, causes the processor 404 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A computer-based method for performing an online auction of an item, which includes a large component and additional components, comprising:
(a) displaying information about the auction item on a website, thereby allowing customers to view the information over the Internet using a web browser;
(b) receiving, from each interested customer, a bid for the large component of the auction item;
(c) selecting a winner of the online auction based on each interested customer's bid;
(d) displaying a solicitation to the winner, the solicitation including the additional components of the auction item; and
(e) receiving, from the winner, a selection of a subset of the additional components, thereby allowing the winner of the auction to customize the auction item that is won.

2. The method of claim 1, wherein steps (b) and (c) comprise:
(b1) receiving, from each interested customer, a bid for the large component of the auction item, each interested customer's bid comprising a number of loyalty rewards points to be redeemed for the large component of the auction item; and
(c1) selecting, as the winner of the online auction, an interested customer bidding a greatest number of loyalty rewards points.

3. The method of claim 1, further comprising:
(f) receiving, from the winner, a request to pay a predetermined amount of additional currency to purchase an add-on component to the auction item.

4. The method of claim 1, wherein step (d) further comprises:
(d1) displaying a solicitation for the winner to select a predetermined number of the additional components, the winner's selection to be such that the total number of additional components selected is equal to the predetermined number.

5. The method of claim 1, wherein step (d) further comprises:
(d1) displaying a solicitation for the winner to select a predetermined number of the additional components, at least one of the additional components having a fee-free option and an upgrade option from which to further select, a selection of the fee-free option requiring the winner to pay no additional currency, and a selection of the upgrade option requiring the winner to pay additional currency.

6. The method of claim 1, further comprising:
(f) displaying additional information about at least one of add-on components and upgrade options in which the winner may be interested, the additional information being based on the winner's selection received in step (e).

7. A computer program product comprising a computer usable medium having control logic stored therein for causing a computer to perform an online auction of an item, which comprises a large component and additional components, the control logic comprising:
first computer readable program code means for causing the computer to display information about the auction item on a website, thereby allowing customers to view the information over the Internet using a web browser;
second computer readable program code means for causing the computer to receive, from each interested customer, a bid for the large component of the auction item;
third computer readable program code means for causing the computer to select a winner of the online auction based on each interested customer's bid;
fourth computer readable program code means for causing the computer to display a solicitation to the winner, the solicitation including the additional components of the auction item; and
fifth computer readable program code means for causing the computer to receive, from the winner, a selection of a subset of the additional components, thereby allowing the winner of the auction to customize the auction item that is won.

8. The computer program product of claim 7, wherein the second and third computer readable program code means respectively further comprise:
means for causing the computer to receive, from each interested customer, a bid for the large component of the auction item, each interested customer's bid comprising a number of loyalty rewards points to be redeemed for the large component of the auction item; and
means for causing the computer to select, as the winner of the online auction, an interested customer bidding a greatest number of loyalty rewards points.

9. The computer program product of claim 7, further comprising:
sixth computer readable program code means for causing the computer to receive, from the winner, a request to pay a predetermined amount of additional currency to purchase an add-on component to the auction item.

10. The computer program product of claim 7, wherein the fourth computer readable program code means further comprises:
means for causing the computer to display a solicitation for the winner to select a predetermined number of the additional components, the winner's selection to be such that the total number of additional components selected is equal to the predetermined number.

11. The computer program product of claim 7, wherein the fourth computer readable program code means further comprises:
means for causing the computer to display a solicitation for the winner to select a predetermined number of the additional components, at least one of the additional components having a fee-free option and an upgrade option from which to further select, a selection of the fee-free option requiring the payment of no additional currency, and a selection of the upgrade option requiring the payment of additional currency.

12. The computer program product of claim 7, further comprising:
sixth computer readable program code means for causing the computer to display additional information about at least one of add-on components and upgrade options in which the winner may be interested, the additional information being based on the winner's selection received by the fifth computer readable program code means.

13. A computer-based method for performing an online auction of multiple items, each of the multiple items comprising a large component and additional components, with each of the large components being substantially identical to each other, the method comprising the steps of:
(a) displaying information about the auction items on a website, thereby allowing customers to view the information over the Internet using a web browser;
(b) receiving, from each interested customer, a bid for the large component;
(c) selecting N interested customers as winners of the online auction based on each interested customer's bid, N being a predetermined integer value;
(d) displaying a solicitation to each winner, the solicitation including the additional components of the auction item; and
(e) receiving, from each winner, a selection of a subset of the additional components, thereby allowing the winners of the auction to customize the auction items that are won.

14. The method of claim 13, wherein steps (b) and (c) comprise:
(b1) receiving, from each interested customer, a bid for the large component, each interested customer's bid comprising a number of loyalty rewards points to be redeemed for the large component of the auction item; and
(c1) selecting N interested customers as winners of the online auction, N being a predetermined integer value, each of the N interested customers bidding a greater number of loyalty rewards points than the other respective interested customers;

15. The method of claim 13, further comprising:
(f) receiving, from at least one of the winners, a request to pay a predetermined amount of additional currency to purchase an add-on component to the auction item.

16. The method of claim 13, wherein step (d) further comprises:
(d1) displaying a solicitation for each winner to select a predetermined number of the additional components, each winner's selection to be such that the total number of additional components selected is equal to the predetermined number.

17. The method of claim 13, wherein step (d) further comprises:
(d1) displaying a solicitation for each winner to select a predetermined number of the additional components, at least one of the additional components having a fee-free option and an upgrade option from which to further select, a selection of the fee-free option requiring the payment of no additional currency, and a selection of the upgrade option requiring the payment of additional currency.

18. The method of claim 13, further comprising:
(f) displaying additional information about at least one of add-on components and upgrade options in which respective winners may be interested, the additional information being based on the respective winners' selections received in step (e).

19. The method of claim 13, wherein an available number of each additional component is less than N, and wherein step (d) further comprises:
(d1) displaying a solicitation for each winner to select a subset of the additional components of the auction item, an order in which respective winners select from the additional components being based on the bids received from the respective winners.

20. The method of claim 13, wherein an available number of each additional component is less than N, and wherein step (d) further comprises:
(d1) displaying a solicitation for each winner to select a subset of the additional components of the auction item, an order in which respective winners select from the additional components being based on a relative order in which the respective winners' bids were received in step (b).

21. A computer program product comprising a computer usable medium having control logic stored therein for causing a computer to perform an online auction of multiple items, each of the multiple items comprising a large component and additional components, with each large component being substantially identical to each other, the control logic comprising:
first computer readable program code means for causing the computer to display information about the auction items on a website, thereby allowing customers to view the information over the Internet using a web browser;
second computer readable program code means for causing the computer to receive, from each interested customer, a bid for the large component;
third computer readable program code means for causing the computer to select N interested customers as winners of the online auction based on each interested customer's bid, N being a predetermined integer value;
fourth computer readable program code means for causing the computer to display a solicitation to each winner, the solicitation including the additional components of the auction item; and
fifth computer readable program code means for causing the computer to receive, from each winner, a selection of a subset of the additional components thereby allowing the winners of the auction to customize the auction items that are won.

22. The computer program product of claim 21, wherein the second and third computer readable program code means respectively comprise:
means for causing the computer to receive, from each interested customer, a bid for the large component, each interested customer's bid comprising a number of loyalty rewards points to be redeemed for the large component of the auction item; and
means for causing the computer to select N interested customers as winners of the online auction, N being a predetermined integer value, each of the N interested customers bidding a greater number of loyalty rewards points than the other respective interested customers.

23. The computer program product of claim 21, further comprising:
sixth computer readable program code means for causing the computer to receive, from at least one of the winners, a request to pay a predetermined amount of additional currency to purchase an add-on component to the auction item.

24. The computer program product of claim 21, wherein the fourth computer readable program code means further comprises:
means for causing the computer to display a solicitation for each winner to select a predetermined number of the additional components, each winner's selection to be such that the total number of additional components selected is equal to the predetermined number.

25. The computer program product of claim 21, wherein the fourth computer readable program code means further comprises:
means for causing the computer to display a solicitation for each winner to select a predetermined number of the additional components, at least one of the additional components having a fee-free option and an upgrade option from which to further select, a selection of the fee-free option requiring the payment of no additional currency, and a selection of the upgrade option requiring the payment of additional currency.

26. The computer program product of claim 21, further comprising:
sixth computer readable program code means for causing the computer to display additional information about at least one of add-on components and upgrade options in which respective winners may be interested, the additional information being based on the respective winners' selection received by the fifth computer readable program code means.

27. The computer program product of claim 21, wherein an available number of each additional component is less than N, and wherein the fourth computer readable program code means further comprises:
means for causing the computer to display a solicitation for each winner to select a subset of the additional components of the auction item, an order in which respective winners select from the additional components being based on the bids received from the respective winners.

28. The computer program product of claim 21, wherein an available number of each additional component is less than N, and wherein the fourth computer readable program code means further comprises:
means for causing the computer to display a solicitation for each winner to select a subset of the additional components of the auction item, an order in which respective winners select from the additional components being based on a relative order in which the respective winners' bids were received by the second computer readable program code means.
